(19) United States
(12) Patent Application Publication
(10) Pub. No.: US 2020/0358392 A1
(43) Pub. Date: Nov. 12, 2020

(54) SOLAR TOWERS

(71) Applicants: Louis Fredrick Kiefer, III, Nashua, NH (US); Jennifer Elizabeth Kiefer, Mason, NH (US); Louis Fredrick Kiefer, IV, New London, NH (US)

(72) Inventors: Louis Fredrick Kiefer, III, Nashua, NH (US); Jennifer Elizabeth Kiefer, Mason, NH (US); Louis Fredrick Kiefer, IV, New London, NH (US)

(21) Appl. No.: 16/868,157

(22) Filed: May 6, 2020

Related U.S. Application Data
(60) Provisional application No. 62/844,468, filed on May 7, 2019.

(51) Int. Cl. H02S 20/10; H02S 40/22; H02S 40/32; H02S 40/38

(52) U.S. Cl. CPC H02S 20/10; H02S 40/38; H02S 40/32; H02S 40/22

(57) ABSTRACT

A system for collecting solar energy for a specified terrestrial surface area, the system includes one or more solar towers each having a free end, a supported end attached to the terrestrial surface area and an exterior collection surface. Photovoltaic elements are secured along the exterior collection surface. The solar energy harvested throughout the day is greater than the total solar energy that impinges upon the specified terrestrial surface area. The solar towers may be arranged in an array to further enhance solar energy collection capabilities.

### CROSS-REFERENCE TO RELATED APPLICATION

This application claims the benefit of priority of U.S. Provisional Patent Application No. 62/844,468, filed May 7, 2019, the disclosure of which is herein incorporated by reference. This patent application is related to U.S. Design Patent Application No. 29/690,355, docket number KIEFE-DES-01, filed on May 7, 2019, and titled “Solar Tower”, which is incorporated herein by reference.

### FIELD

The present invention generally relates to the collection of solar energy to produce electricity. More specifically, the invention relates to one or more 3-dimensional solar towers that can be used to generate significantly more electrical power than standard solar panels for a given terrestrial surface area thereby enabling both solar power generation and other uses on the same terrestrial surface.

### BACKGROUND

The growing shortage and negative repercussions of fossil fuel use have provided incentive for the ongoing pursuit of energy derivation to more sustainable resources. Among the more popular of these technologies has been the photovoltaic solar cell. Although the harnessing of the visible and ultraviolet spectra of the sun's rays to create electricity has had some success; modern solar design systems still experience limitations in electrical conversion efficiency. In addition, design modifications to improve solar energy captured for a given collector area, such as tracking systems, can become cumbersome and require additional costly mechanical and electrical components. In order to further improve solar power and make it a more viable alternative to fossil fuel systems, significant further gains in the yield of electrical power through photovoltaic power systems need to be made.

Although progress in improving photovoltaic efficiency and production costs continues, there are certain situations where the amount of power that can be generated is limited purely by the terrestrial area the installation has to work with. For example, the area of a roof top or size of ones backyard may limit the power that can be generated. The ability to tap into a third dimension (height) would therefore be of value.

The present invention provides for a system of one or more solar towers that can further enhance the solar output from a given ground space area.

### SUMMARY

In one implementation, the present disclosure is directed to a system for collecting solar energy for a specified terrestrial surface area throughout a day. The system comprises one or more solar towers each having a free end, a supported end attached to the specified terrestrial surface and an exterior collection surface. Photovoltaic elements are secured along the exterior collection surface. The area of the photovoltaic collection surface area is greater than the specified terrestrial surface area. The solar energy harvested throughout the day is greater than the total solar energy that impinges upon the specified terrestrial surface area throughout the day.

### BRIEF DESCRIPTION OF DRAWINGS

For the purposes of illustrating the invention, the drawings show aspects of one or more embodiments of the invention. However, it should be understood that the present invention is not limited to the precise arrangements and instrumentalities shown in the drawings, wherein:

FIG. 1 is a representation of a conventional solar panel on a flat terrestrial surface;

FIG. 2a is a representation of a conventional solar panel tilted for better acceptance angle of the sun's rays;

FIG. 2b is a representation of two conventional solar panel tilted for better acceptance angle utilizing a terrestrial area similar to that of a single panel on a flat terrestrial surface;

FIG. 3 is a perspective view of one exemplary embodiment of a 3-dimensional solar tower for collecting solar energy according to the present invention;

FIG. 4 is a perspective view of the tower embodiment in FIG. 3 illustrating photovoltaic collection surface area and the tower's corresponding specified terrestrial surface area;

FIG. 5 is a cutaway perspective view of the solar tower of FIG. 3 showing internal components associated with the tower solar energy collecting system;

FIG. 6a is a perspective view of another exemplary embodiment of a solar tower for collecting solar energy as shown in FIG. 3 now having a modified structure with a single facet (side) made up of solar cells;

FIG. 6b is a perspective view of another exemplary embodiment of a solar tower for collecting solar energy as shown in FIG. 3 now having a modified structure with two faceted sides made up of solar cells;

FIG. 6c is a perspective view of another exemplary embodiment of a solar tower for collecting solar energy as shown in FIG. 3 now having a modified structure with three faceted sides made up of solar cells;

FIG. 6d is a perspective view of another exemplary embodiment of a solar tower for collecting solar energy as shown in FIG. 3 now having a modified structure with four faceted sides made up of solar cells;

FIG. 6e is a perspective view of another exemplary embodiment of a solar tower for collecting solar energy as shown in FIG. 3 now having a modified structure with six faceted sides made up of solar cells;

FIG. 6f is a perspective view of another exemplary embodiment of a solar tower for collecting solar energy as shown in FIG. 3 now having a modified structure with a continuous non-faceted outer side made up of solar cells;

FIG. 7a is a perspective view of another exemplary embodiment of a solar tower for collecting solar energy as shown in FIG. 3 now having a modified structure with a single facet (side) made up of solar cells;

FIG. 7b is a perspective view of another exemplary embodiment of a solar tower for collecting solar energy as shown in FIG. 3 now having a modified structure with two faceted sides made up of solar cells;

FIG. 7c is a perspective view of another exemplary embodiment of a solar tower for collecting solar energy as shown in FIG. 3 now having a modified structure with three faceted sides made up of solar cells;

FIG. 7d is a perspective view of another exemplary embodiment of a solar tower for collecting solar energy as shown in FIG. 3 now having a modified structure with four faceted sides made up of solar cells;

FIG. 7e is a perspective view of another exemplary embodiment of a solar tower for collecting solar energy as shown in FIG. 3 now having a modified structure with six faceted sides made up of solar cells;

FIG. 7f is a perspective view of another exemplary embodiment of a solar tower for collecting solar energy as shown in FIG. 3 now having a modified structure with a continuous non-faceted outer side made up of solar cells;

FIG. 8a is perspective view utilizing an array of solar towers shown in FIG. 3 or any of the FIGS. 6a-7f now in an aligned state;

FIG. 8b is a top down view of the solar tower array in FIG. 8a;

FIG. 9a is perspective view utilizing an array of solar towers shown in FIG. 3 or any of the FIGS. 6a-7f now in a non-aligned state;

FIG. 9b is a top down view of the solar tower array in FIG. 9a;

FIG. 10 is a table of solar panel parameters used in conjunction with modeling the solar electrical production for the solar systems shown in FIGS. 11-16;

FIG. 11 is a graph of representative annual solar electrical production from a solar system as shown in FIG. 1;

FIG. 12 is a graph of representative annual solar electrical production from a solar system as shown in FIG. 2a;

FIG. 13 is a graph of representative annual solar electrical production from a solar system as shown in FIG. 2b;

FIG. 14 is a graph of representative annual solar electrical production from a solar system as shown in FIG. 3;

FIG. 15 is a graph of representative annual solar electrical production from a solar system as shown in FIGS. 8a and 8b;

FIG. 16 is a graph of representative annual solar electrical production from a solar system as shown in FIGS. 9a and 9b;

FIG. 17 is a table of power generation rates and return on investment analysis for the solar systems shown in FIGS. 1-16;

FIG. 18 is a return on investment analysis for the spacing of the system in FIGS. 8a and 8b; and

FIG. 19 is a table of power generation rates and return on investment analysis for a given area using the present invention and comparing that to other options of solar energy collection.

### DETAILED DESCRIPTION

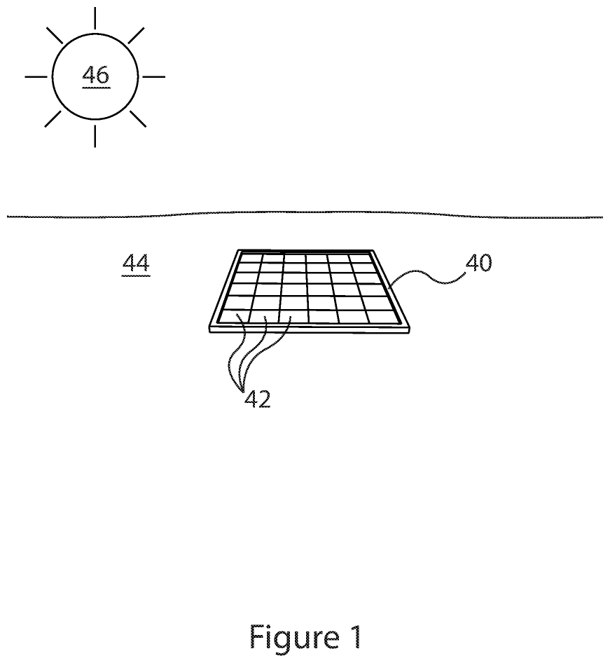

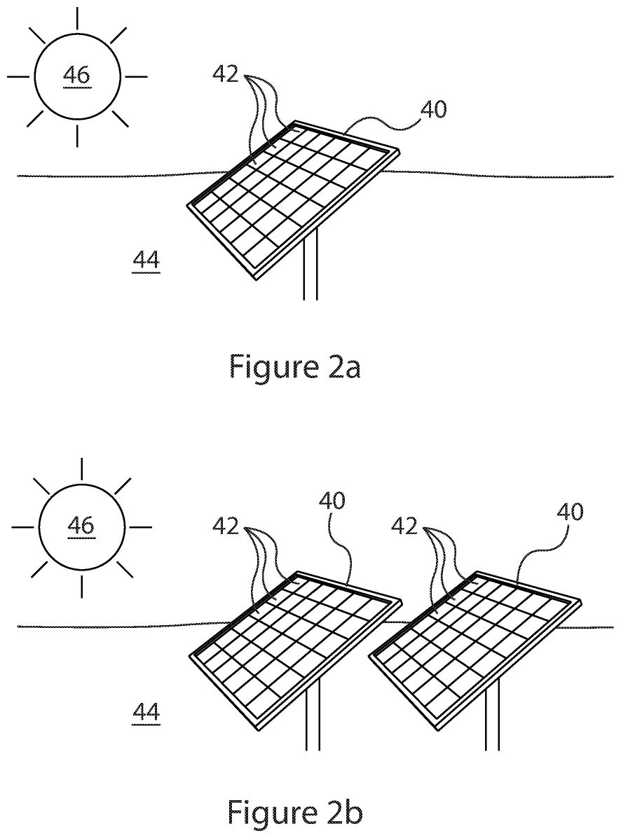

The most basic version of a photovoltaic system is a 2-dimensional panel 40 comprising photovoltaic elements 42. The photovoltaic system is usually supported and attached to a terrestrial surface 44 such as the ground or roof top, FIG. 1. Such a system is passive in that the photovoltaic elements are stationary and the sun 46 moves relative to panel 40 providing a continuously changing angle of incidence θ. The amount of solar energy that can be harvested and turned into electricity is determined from the area of the panel, angle of the sun to the panel and by the path of the sun. In the early morning and late evening the angle of incidence θ is very low and very little solar energy is captured. Tilting panel 40 towards the sun can improve incidence angle θ and reduce the amount of terrestrial surface 44 that is utilized, FIG. 2a. Multiple panels can now be placed upon the same terrestrial surface 44, FIG. 2b. However, there is still a limit to the amount of solar energy that can be harvested from a specified terrestrial surface area 47 because of the 2-dimensional size of the panel 40.

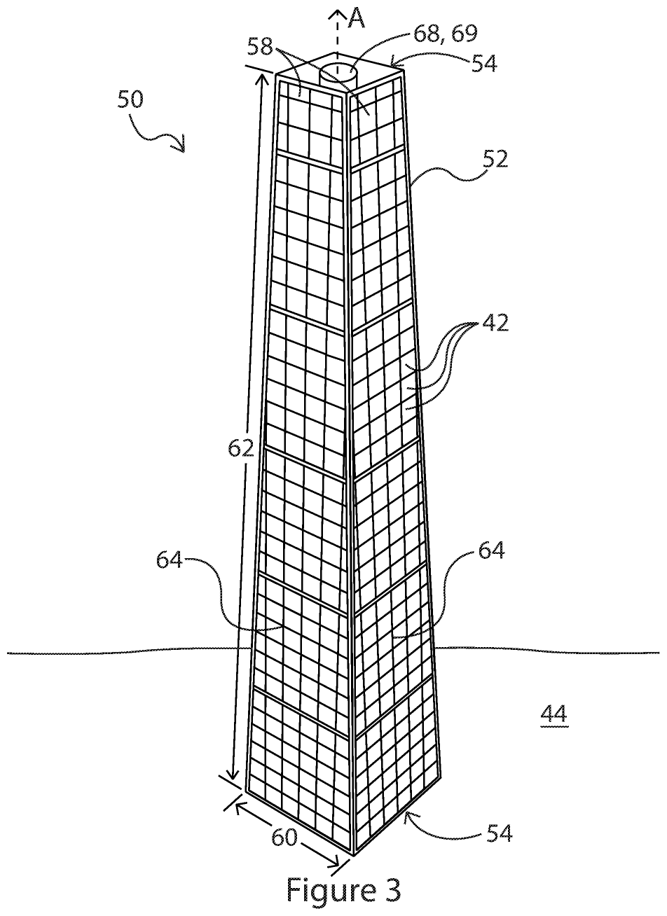

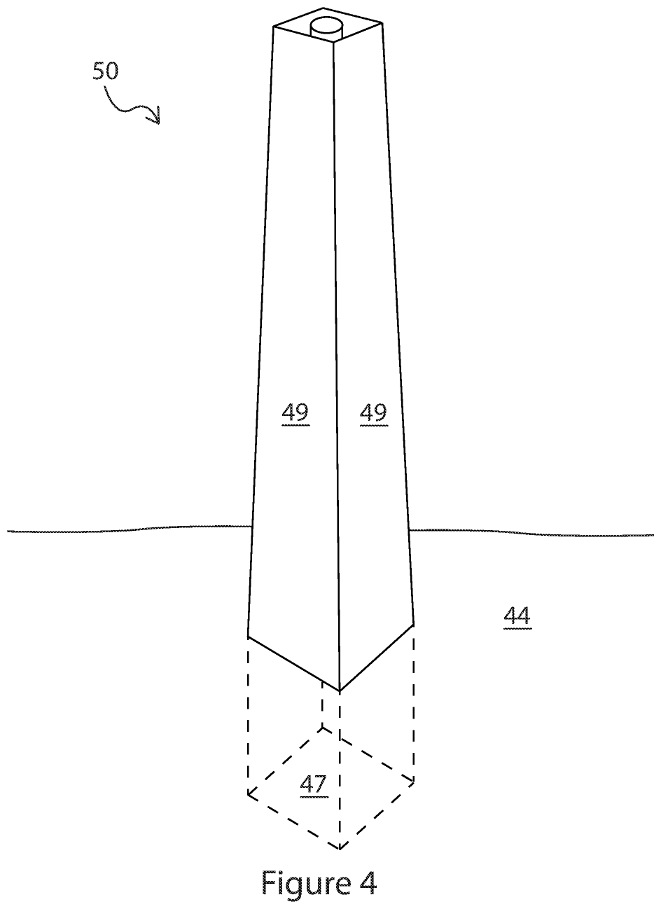

A solar tower system 50, in contrast to a solar panel 40, can provide for a scalable 3-dimensional structure that can more efficiently capture solar energy for a specified terrestrial surface area 47 as illustrated in FIGS. 3-18. Solar tower system 50 may supported and attached to a terrestrial surface 44 such as the ground or roof top. System 50 comprises at least one solar tower 52, FIG. 3. Solar tower 52 has a length, free end 54, a support end 56 attached to the terrestrial surface, an exterior collection surface 58, a tower width 60 and tower length 62. Exterior collection surface 58 may include one or more vertical sides 64 that are oriented to better to capture solar energy throughout the day. Photovoltaic elements 42 are secured vertically along the length of exterior collection surface 58 creating a photovoltaic collection surface area 49 above a specified terrestrial surface area 47, FIG. Solar tower system 50 may include multiple solar towers 52 that are arranged in a solar array 66. Solar tower system 50 can generate several multiples of power over that which is harvested by a standard solar panel system for a given terrestrial area.

Solar tower 52 is able to efficiently capture solar energy from lower sun angles that occur during the morning, evening and winter time. Solar tower 52 can also capture solar energy efficiently during the middle of the day. Solar tower 52 is scalable to different heights increasing by multiple factors the amount of solar energy that can be harvested for a specified terrestrial surface area 47.

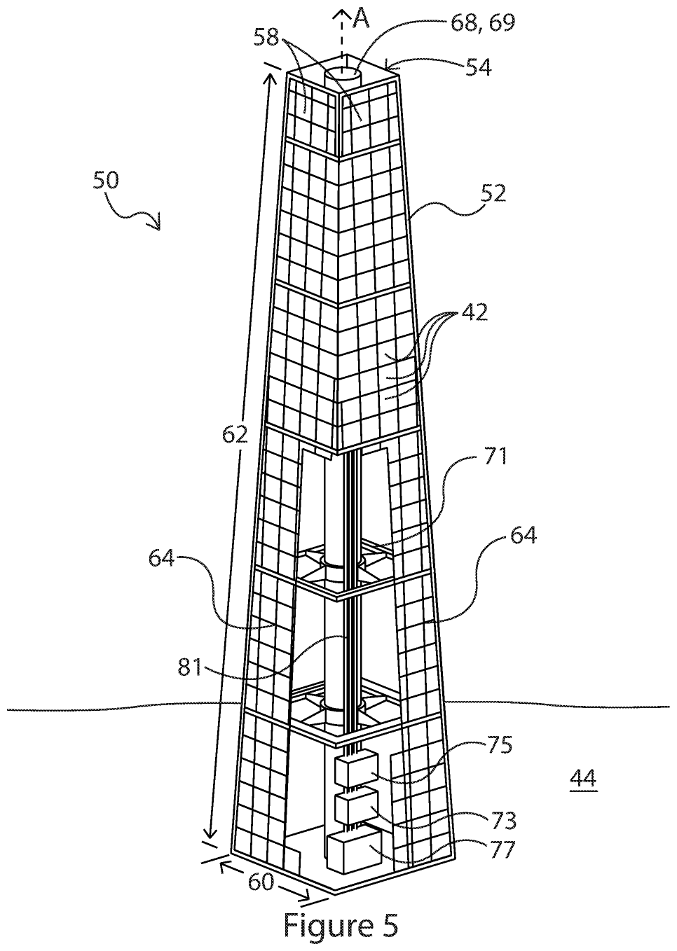

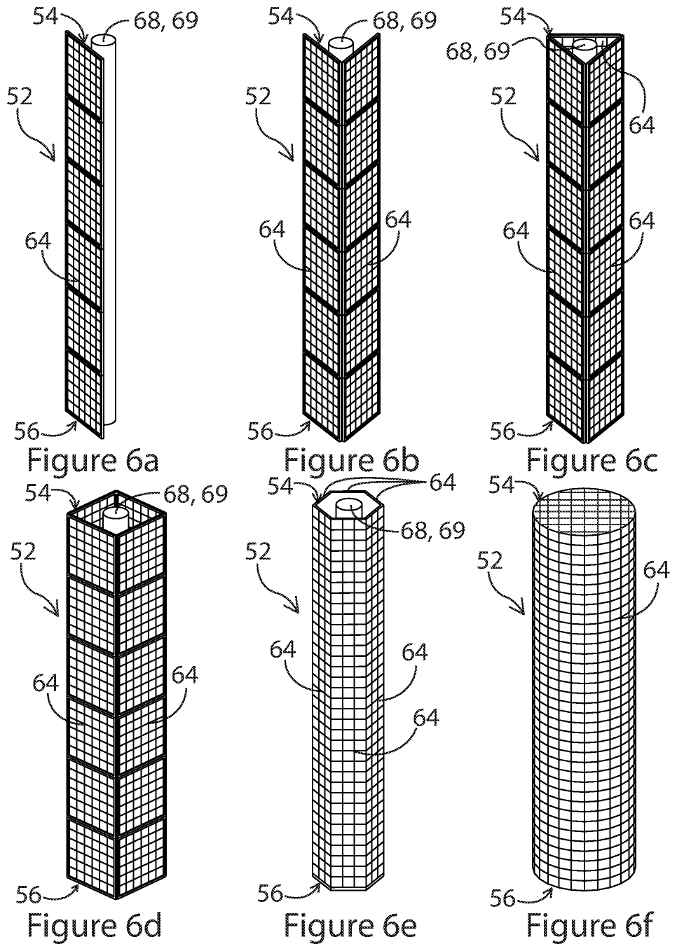

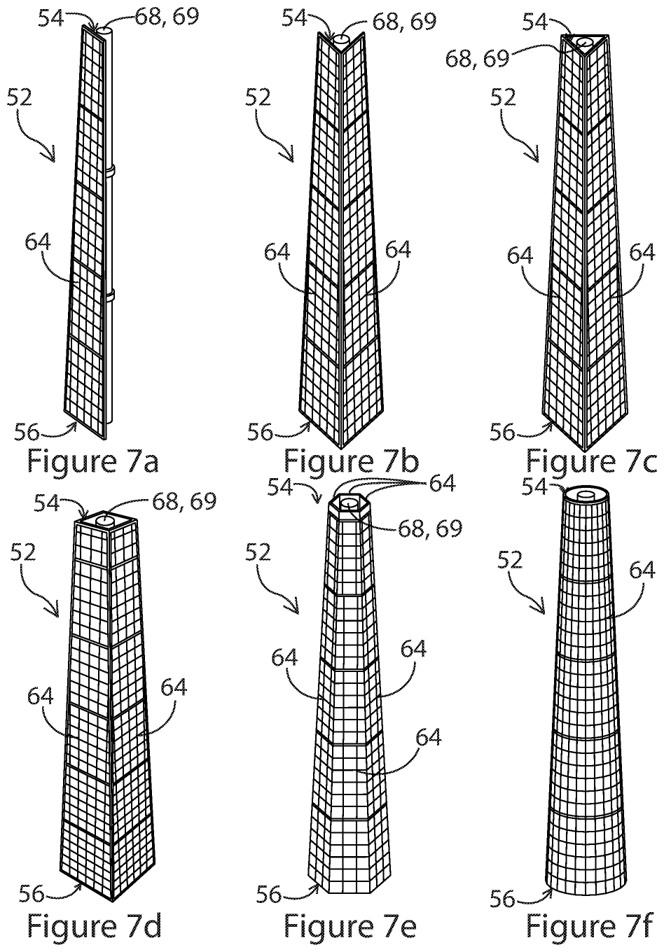

Solar tower 52 may include support structure 68, that includes a post 69 and extensions 71, to which photovoltaic elements 42 are secured. Solar tower 52 may comprise a single side or facet of photovoltaics 42, FIG. 6a. Solar tower 52 may comprise two sides or facets having an adjacent edge, FIG. 6b. Solar tower 52 may comprise three sides or facets encompassing an inner volume or interior that has an exterior surface 58, FIG. 6c. Solar tower 52 may comprise any number of sides or facets as shown in FIG. 6d (four sides) and in FIG. 6e (six sides). Solar tower 52 may also comprise a continuous exterior surface, FIG. 6f When solar tower has three or more faceted sides, the exterior collection surface circumscribes tower axis A with photovoltaic elements. Solar tower 52 may be tapered to narrow from support end 56 (base) to free end 54 (top), FIG. 3. FIGS. 7a-7f are modified versions of FIGS. 6a-f with the towers now tapering to a narrower width towards the top. Any of the solar towers 52 (FIGS. 6a-7f) may comprise photovoltaic element 42 on the free end 54, but only illustrated in FIG. 6f Housed within each tower may be a controller 73, inverter 75 and energy storage device 77, FIG. 5. All components are connected by via electrical cables 81. Controller 73 may have wireless or wired connections to a user interface. It is critical to have solar tower 52 to have a height greater than the base width to provide for improved electrical generation per square foot of terrestrial area. Tower 52 has a tower axis A from the base to top. The tower axis A may be tilted relative to the terrestrial ground to provide for optimal solar collection depending on the latitude at which tower 52 is being used. Tower 52 may also be rotatable to tilt to different angles relative to the terrestrial ground.

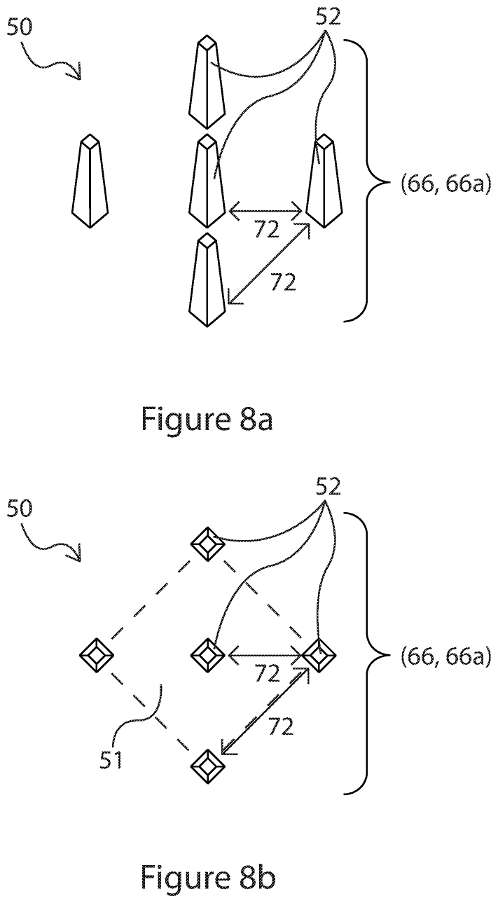

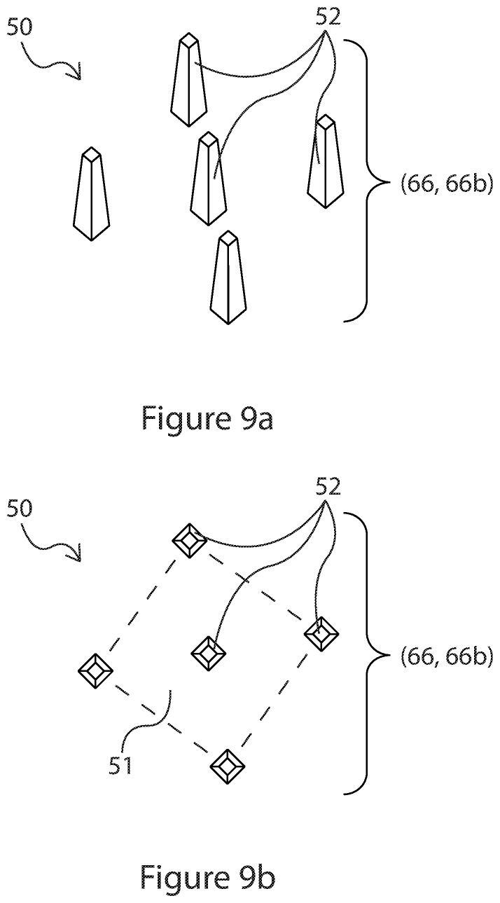

Solar tower system 50 may further comprise a plurality of solar towers 52 arranged upon a terrestrial surface to create a solar tower array 66 (66a and 66b), FIGS. 8a-9b. Associate with tower array 66 is an array solar collection surface area defined as the sum of photovoltaic collection surface area for all towers within the array. Associated with tower array 66 is an array terrestrial surface area 51. Solar towers 52 within solar tower array 70 have tower spacing (a.k.a. gap) 72. The gap between towers 52 should be sufficient to prevent the towers from casting a significant amount of shadows on one another during most of the day. The critical minimum distance is half the tower's height from a diagonal. The length of the tower's shadow is a function of the height of the tower expressed as a ratio to the tangent of the angle of the sun to the objects surface. It is critical to have the specified terrestrial surface area of all towers within the array to be less than 10-percent of the array terrestrial surface area. This percentage is calculated as base area of five towers divided by the area of the whole array. This arrangement both eliminates shadows on other towers and provides for a large amount of useable terrestrial area between towers that can be used for purposes other than photovoltaic energy harvesting. These other purposes for the useable terrestrial area might be agriculture, pasture, parking, recreational use, equipment on the top of a building, etc.

Various array patterns can be formed. FIGS. 8a and 8b show an array of five towers spaced on a square array pattern. The solar towers 52 of the solar tower array 66a in FIGS. 8a and 8b can be aligned to further improve efficiency by capturing solar light reflected between the towers. A non-aligned solar tower array 66b is shown in FIGS. 9a and 9b.

A system 50 of solar towers 52 is oriented so that the ground space and reflective properties of light are maximized for the production of electrical energy. The system allows for minimal design complexity with increased solar yield based on power generated per square foot of ground space utilized. As an added bonus, this new design allows for the ability to collect a percentage of lost solar light reflected from each tower and reflect it back into the ambient surroundings to convert it into electrical energy. Additionally, future modifications in cell efficiency at the electrical level can be incorporated more effectively into a maximized light-collection design allowing for still greater improvements in solar power yield. A light weight, easy to assemble design also encourages the general public to use these solar power systems.

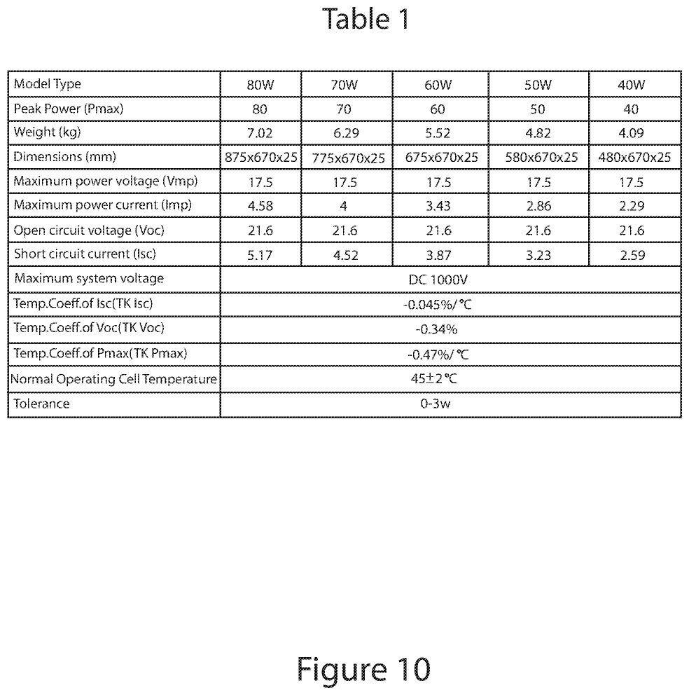

The electrical power harvested by system 50 has been determined by a series of simulations using Aurora Solar® solar simulation software. The dimensions of solar tower 52 were 10 ft. high, with a 2 ft.×2 ft. base, 87.2-degree side angle with the top being lft.xlft. To provide coverage for the geometry of solar tower 52, the exterior collection surfaces were covered with simulated solar cells. The voltages were approximated from tables of data from available solar cells (Table 1), FIG. 10 from Hangzhou Shinefar Solar Energy Technology Co., Ltd., Jan. 31, 2019, herein incorporated by reference. Because the needed cell size (4 in²) was not found to be readily available, the properties including voltage were estimated to be a fraction of values given in Table 1.

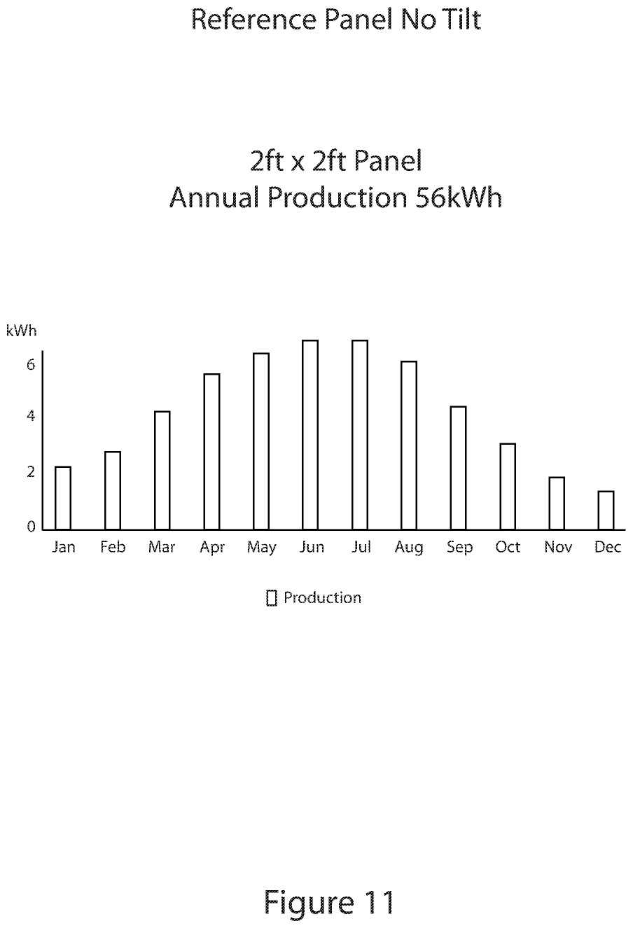

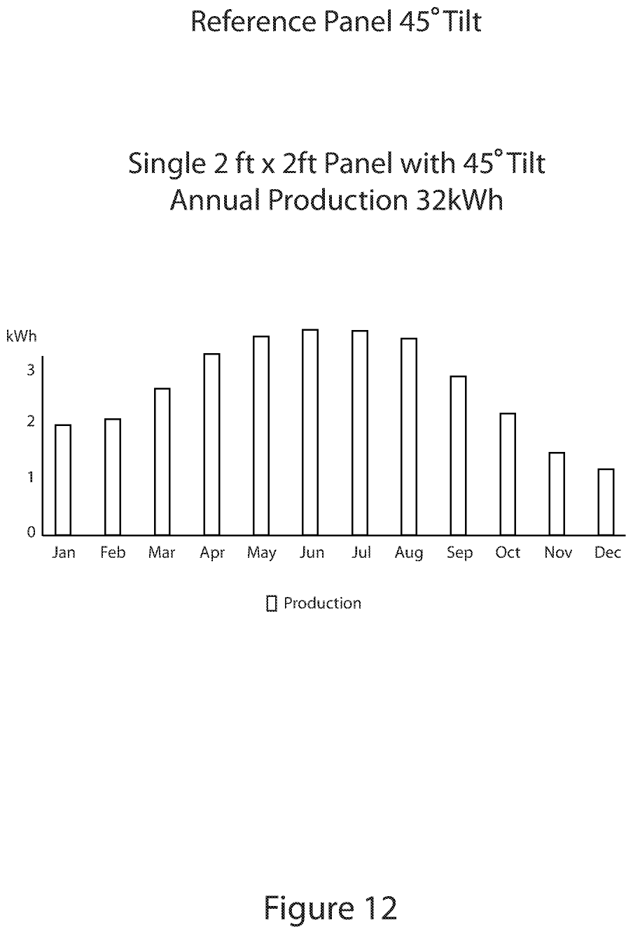

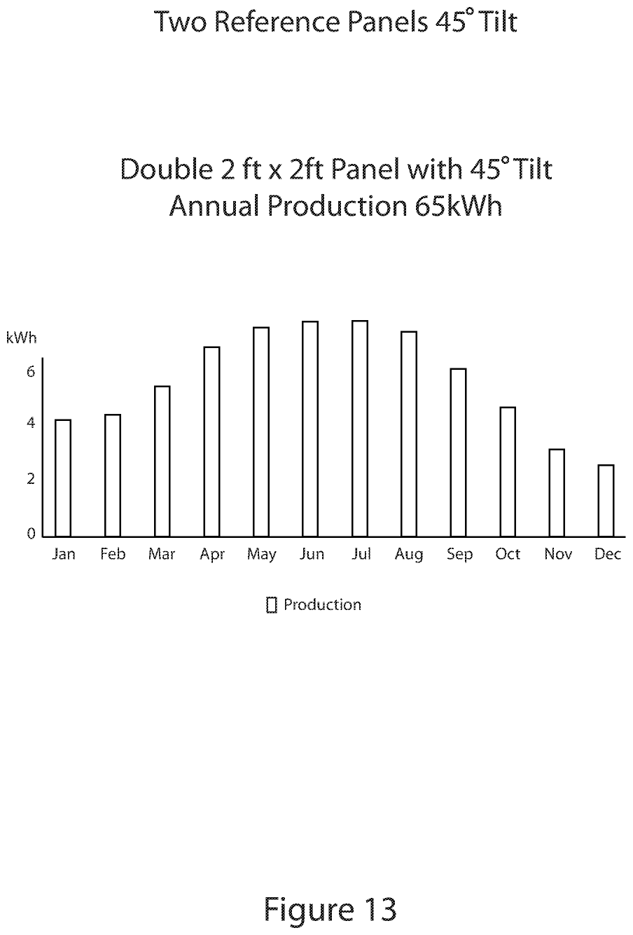

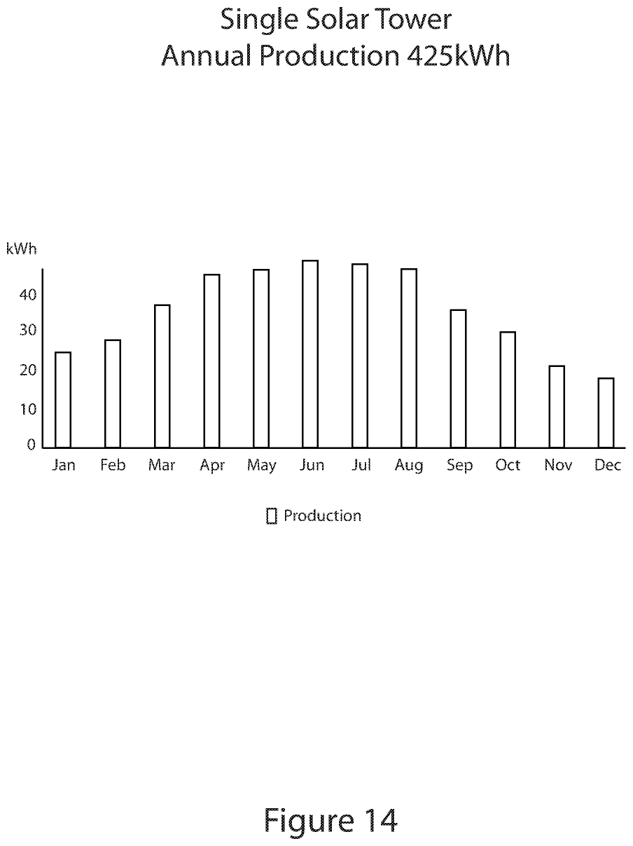

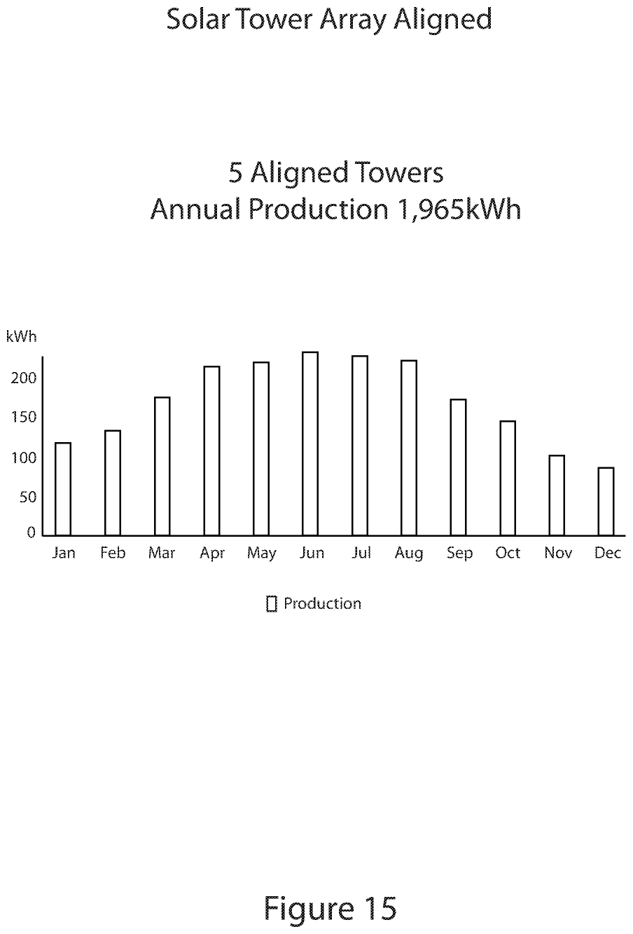

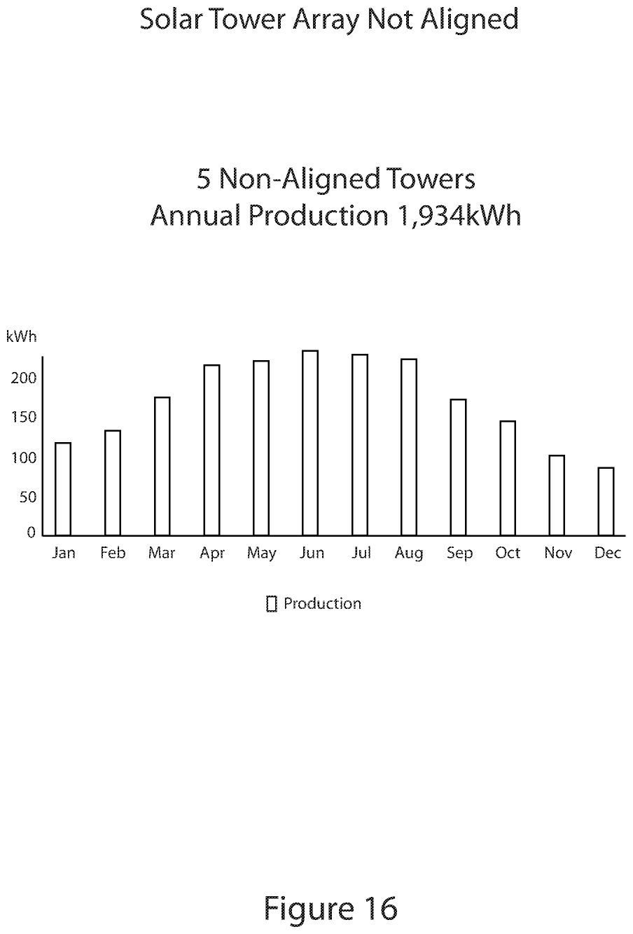

The performance of system 50 is compared to a standard solar panel in FIGS. 11-16. A standard flat panel measuring 2 ft×2 ft (similar to the panel shown in FIG. 1) was used as a control and the harvested energy output is shown in FIG. 11. This was compared to a single 45-degree angled panel (similar to the panel shown in FIG. 2a) with output shown in FIG. 12. This was also compared to two 45-degree panels (similar to the panels shown in FIG. 2b) with output shown in FIG. 13. The annual solar collection data was compared to the system 50 having three different configurations: by itself (tower in FIG. 3) output shown in FIG. 14, an array of five units aligned to capture reflection (towers in FIGS. 8a and 8b) output shown in FIG. 15, and an array of five towers not aligned (towers in FIGS. 9a and 9b) output shown in FIG. 16.

System 50 having one or more solar towers consistently performed higher than the standard panels. The set of five units aligned in order to allow for reflection showed slightly higher averages in yield per year, thus making a case for reflection. The configurations ranked from the least to most amounts of electrical output: the single 45 degree panel was lowest, next the standard flat panel, next the double 45 degree system, next the single solar tower 52, non-reflecting array of towers was second highest, and the most energy collected by the array to collect energy from reflections within the array.

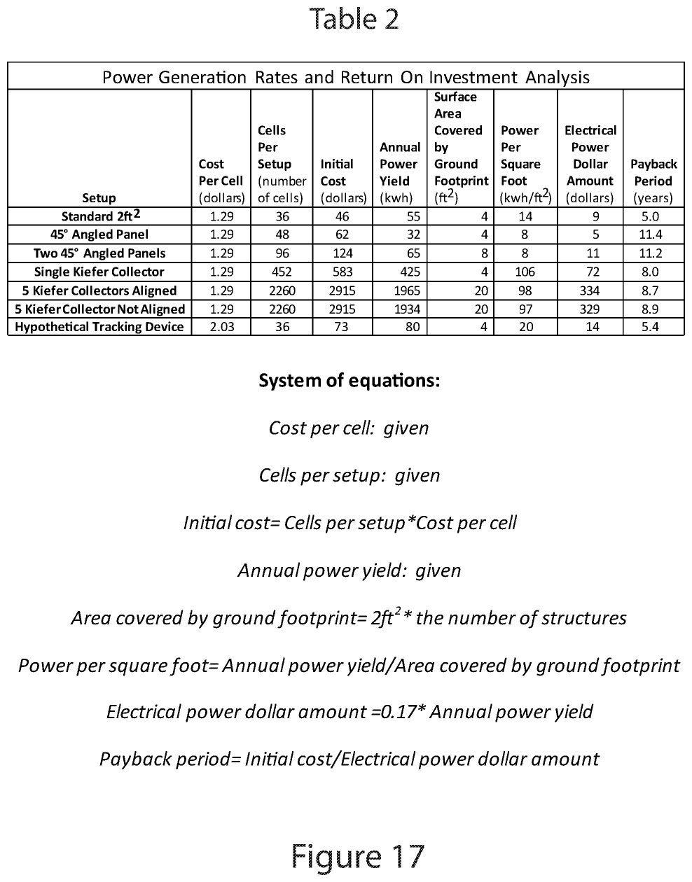

Power generation rates and return on investment analysis for the panels 40 and the current tower system 50 are shown in FIG. 17, Table 2. A month to month solar power output graph can be provided by Aurora's solar simulation software. Using a base value of 17.01 cents per kilowatt hour as taught by Electricity Local, May 6, 2019, herein incorporated by reference, the dollar amount of power can be determined. The approximate cost of a typical arbitrary solar panel is $ 1.29 per 4 in² as taught in Free Clean Solar, May 6, 2019, herein incorporated by reference. The cost of a standard panel and the cost of the present system 50 can be determined by using the cost of a single 4 in² solar cell and multiplying it by the number of cells needed to cover the panel's surface area. The baseline cost can be divided into the dollar amount of the total power generated annually up to a given point to determine the amount of time needed to recuperate the initial investment. Although initial cost for tower system 50 is more than standard panel designs, the power output per square foot of terrestrial area can be up to seven times greater than a standard panel making the present tower system more efficient for locations having low terrestrial ground area.

Since Aurora Solar® solar simulation software did not allow for direct simulation of a tracking solar device, the efficiency per square for power increase for the tracking solar device was approximated to 45% greater than a station panel based on standard approximations as taught by Marsh in “Solar Trackers: Everything You Need to Know”, Aug. 4, 2019, herein incorporated by reference; and the data was thus approximated based upon extrapolation of simulated stationary panel data. Similarly, the additional cost increase was approximated to be 57% over the base cost of a stationary system as taught by Petersen in “Are solar axis trackers worth the additional investment?”, Aug. 14, 2109, herein incorporated by reference. Based on these approximations, power generation rates and return on investment analysis for a Hypothetical Tracking Device are shown in FIG. 17.

The spacing between the towers in system 50 exemplified in FIGS. 8a and 8b was varied in two foot intervals to determine the optimal distance of tower placement per unit area to maximize investment return. The amount of power collected in kilowatt hours was approximated to produce a dollar amount return based upon the Vermont average rate of $ 0.17 per kilowatt hour (Electricity Local, 2019). The cost of the towers was based on upon the cost per 4 in² cell of a standard panel; $1.29 per cell (Free Clean Solar, 2019). The total ground footprint of each design was determined; and the number of arrays possible in a 100 ft² area was calculated and multiplied by the amount of power generated by one array of each type to determine the amount of power each design could produce when confined to a 100 ft² area. The initial cost of the number of towers capable of occupying 100 ft² was then divided by the dollar amount of the power generated in 100 ft² to determine a return on investment per unit area.

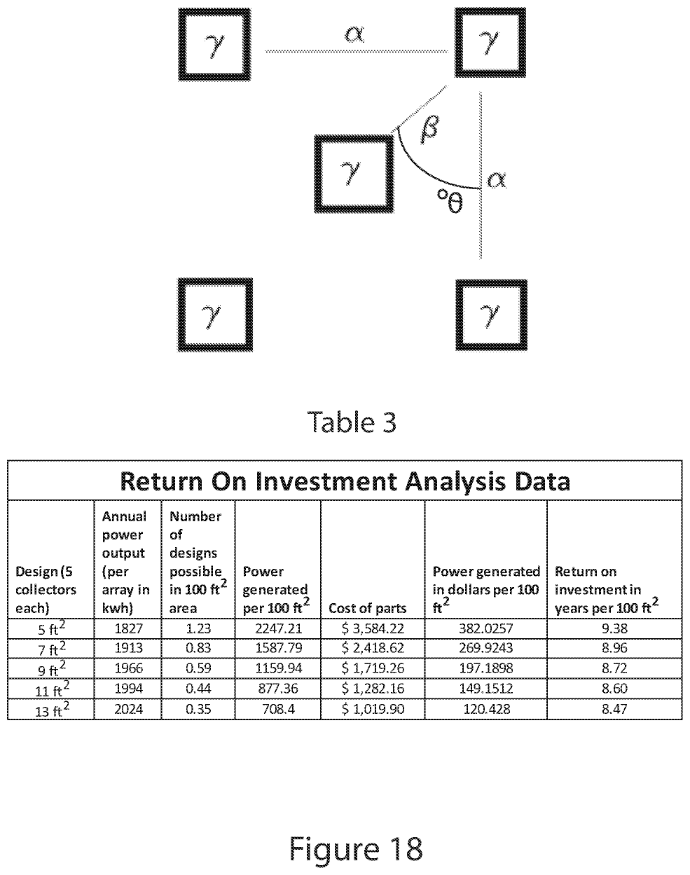

FIG. 18 is provided to explain the arrangement of the towers used to determine the return on investment per unit area. In each analysis, a series of five towers (towers are marked γ) are aligned so that four of the towers are placed at 45° angles from the corners of a central fifth tower at a distance β. Trigonometric analysis defines α=2+(2 β cosθ), this provides the linear distance between the exterior towers (α). This distance was varied in two foot intervals to determine the effectiveness of the spacing between towers in power generation. Each individual tower has a two ft² base, thus the total exterior square area of each design is given by (α+4)², in ft². FIG. 18, Table 3 is the summarized results of each trial. The amount is power generated by each design steadily increases with increased spacing, but begins to plateau after 9 ft². The return on investment decreases slightly with increased spacing, but not significantly. The main design constraints should be determined by the space requirement limitations of the user.

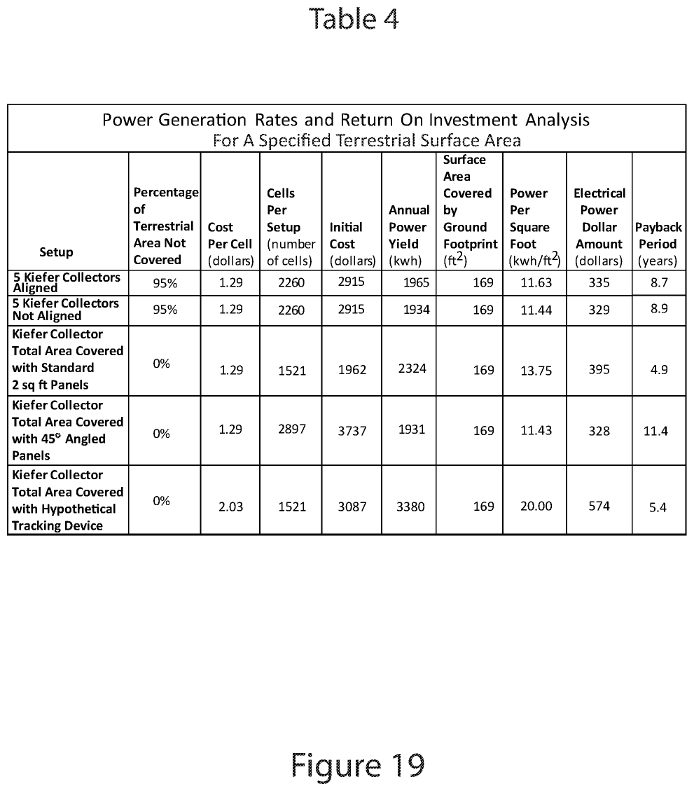

The ability to better facilitate dual use of a given terrestrial surface is shown in FIG. 19, Table 4. Here surface area coverage of the ground was chosen at 169 square feet. This area would equate to the array of towers 52 as shown in FIGS. 8a-9b, 18 and related calculations in Table 2 and 4. Here one can see that only 5% the surface area is covered by the solar towers in that square of the array. Annual power yield for an array of five Kiefer collectors is around 2000 kwh per year. If the same area was covered by standard solar collectors, power output for the year would be around 2300 kwh per year; however that space would have to be dedicated solely to solar power generation for the standard solar collectors. So for similar yearly power outputs, 95% of the terrestrial area can still be used for other purposes with the tower system disclosed in the present invention. This remaining 95% can be used for agriculture, pasture, parking, recreational use, equipment on the top of a building, etc.

While several embodiments of the invention, together with modifications thereof, have been described in detail herein and illustrated in the accompanying drawings, it will be evident that various further modifications are possible without departing from the scope of the invention. The scope of the claims should not be limited by the preferred embodiments set forth in the examples, but should be given the broadest interpretation consistent with the description as a whole.

What is claimed is:

1) A system for collecting solar energy for a specified terrestrial surface area throughout the day, comprising:
a) a solar tower having a length, tower axis, a free end, a supported end attached to the specified terrestrial surface area and an exterior collection surface;
b) photovoltaic elements having a photovoltaic collection surface area , wherein the photovoltaic elements are secured along the exterior collection surface; and
c) wherein the area of the photovoltaic collection surface area is greater than the specified terrestrial surface area, wherein solar energy harvested throughout the day is greater than the total solar energy that impinges upon the specified terrestrial area throughout the day.

2) A system as recited in claim 1, further comprising a support structure at the supported end for supporting the solar tower perpendicular to the terrestrial surface.

3) A system as recited in claim 1, wherein the tower axis is tilted from a normal relative to the specified terrestrial surface.

4) A system as recited in claim 1, wherein the exterior collection surface circumscribes the central axis with photovoltaic elements.

5) A system as recited in claim 4, wherein the exterior collection surface has one from the group consisting of three sides, four sides and six sides.

6) A system as recited in claim 1, wherein the solar tower has an aspect ratio of length to width that is greater than one to one.

7) A system as recited in claim 1, wherein the photovoltaic element are secured to cover substantially the entire exterior collection surface of the solar tower.

8) A system as recited in claim 1, further comprising photovoltaic elements on the free end.

9) A system as recited in claim 1, further comprising an energy storage device connected to receive electricity from the photovoltaic elements.

10) A system as recited in claim 9, wherein the energy storage device is located within the solar tower.

11) A system as recited in claim 1, wherein the solar tower is hollow.

12) A system as recited in claim 1, wherein the solar tower narrows from the support end to the free end.

13) A system as recited in claim 1, wherein the solar tower is an array of solar towers positioned on a terrestrial surface, wherein the array determines an array solar collection surface area.

14) A system as recited in claim 13, wherein each the solar tower is a polygon having faceted sides that allow reflected solar energy to be redirected to other solar towers in the array.

15) A system as recited in claim 13, wherein the photovoltaic collection surface area of all solar towers is greater than the array terrestrial surface area.

16) A system as recited in claim 13, wherein each the solar tower has an aspect ratio of length to width that is greater than one to one.

17) A system as recited in claim 13, wherein each the solar tower is positioned in an array that is at least one from the group consisting of a square array, rectangular array and a hexagonal close packed array.

18) A system as recited in claim 13, wherein the array of solar towers has a gap between each solar tower at the support end.

19) A system as recited in claim 13, wherein the array of solar towers has a diagonal gap between each solar tower at the support end; wherein the diagonal gap is at least half the height of the tower.

20) A system as recited in claim 13, wherein the specified terrestrial surface area of all towers within the array is less than 10-percent of the array terrestrial surface area.
